(19) United States
(12) Patent Application Publication
(10) Pub. No.: US 2005/0128674 A1
(43) Pub. Date: Jun. 16, 2005

(54) Ceramic chuck

(75) Inventors: Tsuneaki Ohashi, Nagoya-City (JP); Naohito Yamada, Kasugai-City (JP); Hiroya Sugimoto, Chiryu-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 11/003,285

(22) Filed: Dec. 3, 2004

(30) Foreign Application Priority Data
Dec. 11, 2003 (JP) 2003-412712

(51) Int. Cl. H01H 1/00

(52) U.S. Cl. 361/233

(57) ABSTRACT

An object of the present invention is to provide a ceramic chuck for mounting a wafer so that the number of particles adhered onto the wafer after chucking can be reduced while maintaining a desired Young's Modulus of the chuck. A ceramic chuck 1 has a surface layer 2 contacting a wafer “W” and a substrate portion 6. The surface layer 2 and substrate portion 6 are produced by co-sintering and the surface layer 2 has a porosity of 1% or higher and 10% or lower and larger than that of the substrate portion 6.

This application claims the benefit of Japanese Patent Application P 2003-412712, filed on Dec. 11, 2003, the entirety of which is incorporated by reference.

### BACKGROUND OF THE INVENTION

1. Field of the Invention

The invention relates to a ceramic chuck such as electrostatic and vacuum chucks.

2. Related Art Statement

An electrostatic chuck has been used for attracting and mounting a semiconductor wafer in steps of moving, exposing, film forming including CVD and sputtering, fine processing, cleaning, etching, dicing or the like of the wafer up to now. Further, a ceramic heater and an electrode system for generating high frequency have been commercialized for the heat treatment of a semiconductor wafer. It has been recently applied a finer design rule of a semiconductor such as fine pitch of 0.13 μm or smaller. It is required to further reduce the adhesion of particles onto the back face of a silicon wafer.

According to Japanese patent publication 11-289, 003A, the surface layer of a chuck is formed of an SiC film produced by CVD. According to table 1 of the publication, the volume resistivity of the surface layer is as high as 1×10¹⁰Ω·cm. Further, according to Japanese patent publication 9-260, 471A, a silicon carbide film is coated onto the surface of a vacuum chuck by chemical vapor deposition to improve the resistance of the chuck against abrasion.

### SUMMARY OF THE INVENTION

According to the above described ceramic chucks, however, the surface is too dense so that particles are easily adhered onto the back face of a wafer attracted on the chuck to result in damages on the back face of the wafer. Further, CVD process requires a treatment at a high temperature providing a risk of denaturing or deformation of a material forming the chuck.

It is demanded for a chuck a function of controlling the temperature of a wafer during various processes such as film forming, etching, heat treatment or testing. In a film forming process such as CVD and PVD, it is important to provide a heating element in the chuck for effectively heating the wafer. It is also important to effectively flowing thermal energy in a wafer downwardly through the chuck during a specific process such as etching. It is further required to mount a wafer in a specific shape (flat shape in most cases).

The rigidity of the chuck product is an important factor for properly mounting a wafer. Although the rigidity of a ceramic chuck depends on the shape of the chuck product as a matter of course, the shape of chuck for use in treatment of a wafer is usually limited to a circular plate. The selection of a material is thus considered to be critical.

On the other hand, particles are more or less adhered onto a wafer before chucking. If the number of particles adhered onto the wafer is increased during many steps before obtaining a desired device thereon, the yield of the product may be considerably reduced. Although it is possible to reduce particles adhered onto the wafer by cleaning process, it is preferred to prevent the increase of number of particles on the wafer in each step on the viewpoint of manufacturing cost.

An object of the present invention is to provide a ceramic chuck for mounting a wafer so that the number of particles adhered onto the wafer after chucking can be reduced while maintaining a desired Young's modulus of the chuck.

The present invention provides a ceramic chuck comprising a surface layer contacting a wafer and a substrate portion, wherein the surface layer and the substrate portion are produced by co-sintering and wherein the surface layer has a porosity of 1% or higher and 10% or lower and larger than that of said substrate portion.

It is proved that particles on the back face of a wafer can be trapped in pores in the surface layer of the chuck by providing an appropriate amount of pores in the surface layer as described above. If all the particles on the wafer are not trapped in the pores of the surface layer, the increase of particles adhered on the back face of the wafer can be suppressed. Such suppression of particles on the back face gives considerable influence on the yield of a device produced on the wafer. It is further possible to prevent the problem that the back face of the wafer is supported on the particles adhered thereon. It is especially useful when the wafer is to be mounted while preserving a low flatness as in the case of lithography. On the viewpoint, the porosity of the surface layer is made 1% or higher, and may preferably be 3% or higher.

If the porosity of the surface layer is too large, there is a risk that the performance of adsorption and removal of a wafer and gas removal may be adversely affected. The mechanical strength is also lowered to result in removal of grains from the ceramic material microscopically. It is proved that such removal of grains may be a cause of increasing the number of particles adhered onto the back face of the wafer. On the viewpoint, the porosity of the surface layer is made 10% or lower, and more preferably be 5% or lower.

The porosity of the substrate portion may preferably be 3.0 percent or lower, and more preferably be 1.0 percent or lower, for improving the Young's modulus of the chuck.

A difference of the porosity of the surface layer and that of the substrate portion may preferably be 1.0 percent or larger and more preferably be 2.0 percent or larger on the viewpoint of the present invention. Further, a difference of the porosity of the surface layer and that of the substrate portion may preferably be 9.0 percent or smaller and more preferably be 4.0 percent or smaller on the viewpoint of the present invention.

As described above, it is required that the contact face of the chuck to a wafer is made of a material containing a controlled amount of pores for preventing the positional shift and damages of the wafer due to particles. It is also considered that the substrate portion is made of a material having an excellent rigidity at the same time. It is further found that the porosity considerably affects Young's modulus of the chuck. The present invention is based on such discoveries.

According to the present invention, a controlled amount of pores described above are given only to the surface layer, so that the rigidity and Young's Modulus as a whole chuck can be maintained.

It is considered that the surface layer and substrate portion of the chuck be integrated by means of joining with a resin or a metal. In both cases, however, the metal or resin joining layer is softer than the ceramic material forming the chuck. Such joining layer made of the softer material prevents improvement of rigidity of the chuck. Further, if the surface layer would have been produced by coating such as CVD, it becomes very difficult to form a specific amount of pores, so that the peeling of and cracks in the surface layer may easily occur.

According to the present invention, ceramic material forming the surface layer and that forming the substrate layer are co-fired so that the surface layer and substrate portion are joined and integrated with each other. It is thus possible to relax the stress at the interface of the surface layer and substrate portion during sintering and to join them strongly. The peeling of the surface layer from the underlying substrate portion can be thereby prevented.

These and other objects, features and advantages of the invention will be appreciated upon reading the following description of the invention when taken in conjunction with the attached drawings, with the understanding that some modifications, variations and changes of the same could be made by the skilled person in the art.

### BRIEF DESCRIPTION OF THE DRAWINGS

FIG. 1 is a cross sectional view schematically showing a vacuum chuck 1 according to an embodiment of the present invention.

FIG. 2 is a cross sectional view schematically showing an electrostatic chuck 1A according to another embodiment of the present invention.

FIG. 3 is a diagram for explaining the concept of drawing of particles 13 into pores 12 of a surface layer 12 of a ceramic chuck.

FIG. 4 is a photograph showing a backscattering electron image of a laminated body of a substrate portion and surface layer in a sample of example 5.

FIG. 5 is a photograph showing the result of Al element mapping of a laminated body of a substrate portion and surface layer in a sample of example 5.

### PREFERRED EMBODIMENTS OF THE INVENTION

The present invention will be described further, referring to the attached drawings.

The kind of a ceramic chuck is not particularly limited, as far as the chuck has a function of chucking a wafer, and may be an electrostatic chuck or vacuum chuck. In the case of electrostatic chuck, although it is preferred that an electrostatic electrode is embedded in the chuck, an electrostatic chuck electrode may be provided on the back face of the electrostatic chuck. In the case of vacuum chuck, a vacuum suction hole is formed in a substrate and a semiconductor wafer is mounted on the surface of the substrate. Air is suctioned through the vacuum suction hole to attract the wafer by a difference of pressure in the hole and in atmosphere over the wafer. A heat generator and electrode for generating high frequency may be embedded in the ceramic chucks.

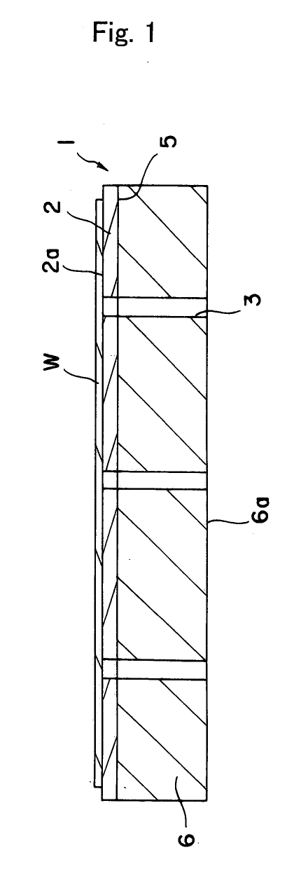

FIG. 1 is a cross sectional view schematically showing a vacuum chuck 1 according to an embodiment of the present invention. The chuck 1 has a substrate portion 6 and a surface layer 2 provided on the substrate layer 6. A plurality of suction holes 3 are formed from a back face 6a of the substrate portion 6 to a wafer mounting face 2a of the surface layer 2, so that a wafer “W” can be attracted on the mounting face 2a. 5 represents an interface between the substrate portion 6 and surface layer 2.

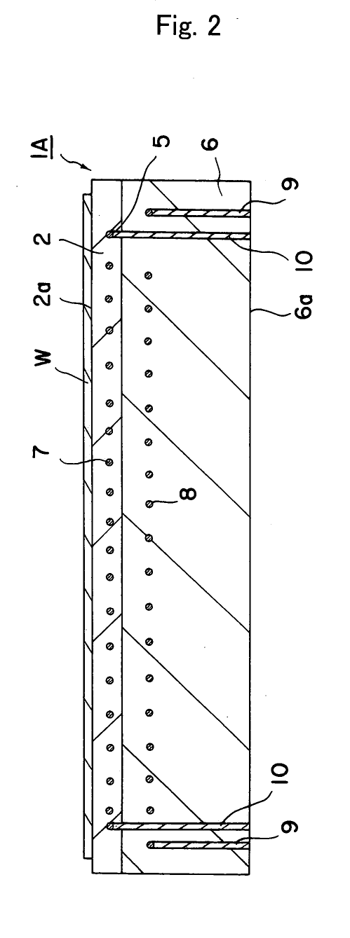

FIG. 2 is a cross sectional view schematically showing an electrostatic chuck 1A according to another embodiment of the present invention. The chuck 1A has a flat plate-shaped substrate portion 6 and a surface layer 2 provided on the substrate portion 6. A heating resistance 8 is embedded in the substrate portion 6. Terminals 9 are connected to the ends of the heating resistance 8 and face the back face 6a. A means for electrical supply not shown is connected to the terminal 9. Further, an electrostatic chuck electrode 7 is embedded in the surface layer 2 at a specific depth. The end of electrode 7 is connected to the terminal 10, which is connected to an outer means for electrical supply.

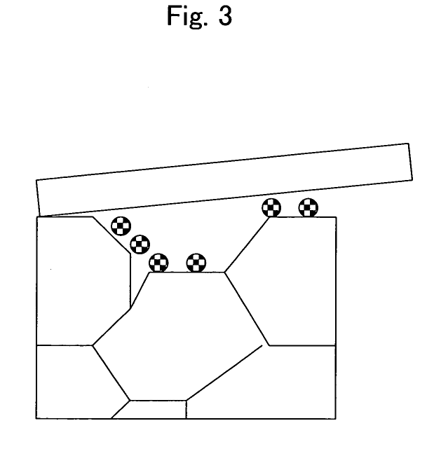

As shown in a schematic diagram of FIG. 3, particles 13 are trapped in open pores 12 formed among grains 11, so that the adsorption of particles onto the back face of the wafer can be prevented.

The surface layer to be contacted with a wafer may preferably be of a high purity for preventing metal contamination with alkali and transition metals. The total cost of the ceramic chuck is, however, increased when the whole chuck is made of a material of a high purity. It is thus preferred that the purity of the surface layer is made higher than that of the substrate portion for reducing the cost of the chuck product. On the viewpoint, a total content of alkali and transition metals of a ceramic material forming the surface layer may preferably be 50 ppm or lower. Further, a total content of alkali and transition metals may not be or may be 50 ppm or higher in a ceramic material forming the substrate portion.

Although it is needed that ceramic materials forming the surface layer and substrate portion are selected considering various kinds of requirements as a whole, SiC base materials are preferred, on the viewpoint of obtaining rigidity and preventing electrification at the same time. When the chuck is applied as a chuck having heating function, SiC of a high resistance, AlN and alumina based ceramics are preferred. In both of the ceramic materials, it is preferred that the main component occupies 67 percent or more of the material while leaving a room for a sintering agent and the other additives.

The material and manufacturing method for the electrostatic chuck, electrode for generating high frequency and heat generator (heater element) are not particularly limited, and any of known materials and manufacturing methods may be applied. For example, the material includes tungsten, molybdenum, tungsten carbide and molybdenum carbide. The electrodes and heating resistances may be produced by embedding a metal wire, metal mesh or metal foil in a ceramic shaped body and by sintering the shaped body. Alternatively, the electrodes and heating resistances may be produced by screen printing a film with a paste and firing the film, by thermal spraying or by aerosol deposition.

When the surface layer and substrate portion are made of AlN, the electrodes and heater element may preferably be made of molybdenum. When the surface layer and substrate portion are made of SiC, the electrodes and heater elements may preferably be made of tungsten. The shape of the electrode or heater element may preferably be a coil or metal mesh on the viewpoint of ease of embedding. The wire diameter φ of, the wire or metal mesh may preferably be 50 to 500 μm. The metal mesh may preferably be of 10 mesh to 325 mesh. The metal materials may preferably have a purity of 99.5 percent or more. Further, the metal materials may preferably be annealed in advance to remove dislocations therein.

The surface of the chuck may be processed to form embossed portions or grooves thereon, depending on various applications. Such processing leaves gaps on the surface of the chuck, which may be filled with helium or a gas of a high thermal conduction at a pressure which does not cancel the adsorption force required for chucking.

The surface layer and substrate portion may be joined and integrated with each other by any methods not particularly limited. For example, a pressurized sintering may be used. According to this method, ceramic fine particles are sintered to form the substrate portion at a combination of a temperature and a pressure sufficient for making the substrate portion highly sintered. Ceramic coarser particles, which would provide a porous body by sintering at the above combination of temperature and pressure, are sintered with the fine particles at the same time to provide the surface layer. Such pressurized sintering methods include hot pressing and hot isostatic pressing. According to the thus obtained integrated sintered body, the surface layer and substrate portion are strongly integrated and joined with each other, and the ceramic microstructure of the surface layer and that of the substrate portion are continuous at the interface in a microscopic view. Moreover, both in the surface layer and substrate portion, the ceramic finer and coarser particles are subjected to the similar sintering process under the same temperature and pressure conditions, resulting in a reduction of residual stress along the interface of the surface layer and substrate portion. The joining strength of the surface layer and substrate portion is high or stable and joining defects can be reduced.

According to a preferred embodiment, the volume resistivity of the surface layer at room temperature is 1×10⁹ Ω·cm or lower. It is thus possible to hold a wafer at a temperature near room temperature with electrostatic force.

According to a preferred embodiment, the surface layer has a thickness of 0.5 mm or more. Further, according to a preferred embodiment, the thickness of the surface layer is 25 percent or less of that of the ceramic chuck. The manufacturing cost of the ceramic chuck can be reduced by increasing the ratio of the thickness of the substrate to that of the chuck as such.

An interface may be provided between the surface layer and substrate portion so that the surface layer and substrate portion contact each other. Alternatively, one or two or more intermediate layer(s) may be provided between the surface layer and substrate portion. The material of the intermediate layer is not particularly limited. When the surface layer and substrate portion are made of ceramic materials having the same main component and different kinds of aids or different amounts of aids, or when the surface layer and substrate portion are made of SiC or AlON, the material of the intermediate layer may preferably be sialon, silicon nitride, boron nitride, alumina or AlON.

The ceramic chuck of the present invention may be used as chucks for a system of producing semiconductors, Si wafer, the other substrates for devices, or an FPD substrate such as liquid crystal.

### EXAMPLES

### Example of Production of a Vacuum Chuck

The vacuum chuck 1 shown in FIG. 1 and table 1 was produced. 2 percent of boron carbide powder having a purity of 98 percent or more and an average grain diameter of 0.8 μm was added, as a sintering aid, to β-type SiC powder having an average grain diameter of 0.2 μm and a purity of 99.9 percent (Fe 480 ppm; Ti 170 ppm; Cr 60 ppm; Ni 140 ppm; Na<1 ppm; K<1 ppm) , mixed together with an organic binder and granulated to obtained granulated powder for the substrate portion 6. The granulated powder was filled in a metal mold having a diameter φ of 302 mm and pressed at a pressure of 10 MPa to obtain a shaped body of the substrate portion 6. According to example 5, AlN powder having a purity of 99.9 percent or more was further blended in an amount of 20 percent.

β-type SiC powder of high purity (Fe<1 ppm; Ti 2 ppm; Cr<1 ppm; Ni<1 ppm; Na<1 ppm; K<1 ppm; an average grain diameter of 1.3 μm) , boron carbide powder having a purity of 99.5 percent or higher and an average grain diameter of 0.8 μm and carbon powder having an average grain diameter of 0.3 μm were mixed together with an organic binder and granulated to obtain granulated powder. The granulated powder was filled on the shaped body for the substrate portion 6 in the metal mold and pressed again at a pressure of 8 MPa to shape the surface layer 2.

The thus obtained shaped body was dewaxed and sintered in a hot pressing system to obtain a hybrid (composite) SiC sintered body. The sintered body was then processed to obtain a disk-shaped work having an outer diameter of 295 mm, a whole thickness of 10.5 mm and a surface layer having a thickness of 0.5 to 1.5 mm and a flatness of 1 to 4 μm. Twelve through holes 3 were formed in the disk-shaped work so that the twelve holes 3 are positioned at substantially same intervals. The through holes 3 were used for vacuum chucking.

A 300 mm wafer “W” was attracted onto the work at 35° C. The number of particles on the back face of the wafer after the adsorption was measured by “SP1” supplied by KLA-Tencor and compared with the number of particles on the wafer not yet attracted. When the wafer was not attracted, the number of particles on the back face of the wafer was about 500. Samples were cut out from the hybrid sintered body and the porosities were measured by Archimedes' method. The purity of the surface layer was determined by sampling to prove that the content of alkali and transition metals were 4 to 23 ppm. The electrical resistance was determined by measuring surface current by means of four-terminal method to prove that the resistance was 1×10⁹ Ω·cm or lower. Plate shaped samples including the materials of the surface layer and substrate portion were cut out and subjected to measurement of Young's modulus by resonance method. According to sintered bodies shown in table 1, the amount of boron carbide as a sintering aid was controlled in a range of 0 to 1.5 weight percent, the amount of carbon powder was controlled in a range of 0 to 10 weight percent, the sintering temperature was controlled in a range of 1900 to 2350° C. and the pressure during hot pressing was controlled in a range of 2 to 50 MPa to adjust the porosity of the surface layer.

TABLE 1

| | Com- | | | | | | Com- |
|---|---|---|---|---|---|---|---|
| | parative | | | | | | parative |
| | Exam- | Inventive examples | | | | | Example |
| | ple 1 | 1 | 2 | 3 | 4 | 5 | 2 |
| Porosity of | <0.1 | 1 | 3 | 5 | 10 | 5 | 20 |
| Surface | | | | | | | |
| layer | | | | | | | |
| (%) | | | | | | | |
| Thickness | 1.5 | 0.8 | 1.5 | 0.5 | 0.7 | 0.5 | 1.5 |
| of | | | | | | | |
| Surface | | | | | | | |
| Layer | | | | | | | |
| (mm) | | | | | | | |
| Porosity of | <0.1 | 0.2 | 0.4 | 0.7 | 0.9 | <0.1 | 3 |
| Substrate | | | | | | | |
| Portion | | | | | | | |
| (%) | | | | | | | |
| Number of | 7600 | 1870 | 680 | 740 | 810 | 860 | 13450 |
| Particles | | | | | | | |
| >0.15 μm | | | | | | | |
| particles/ | | | | | | | |
| wafer) | | | | | | | |
| Young's | 470 | 450 | 440 | 440 | 380 | 470 | 300 |
| Modulus | | | | | | | |
| (Gpa) | | | | | | | |

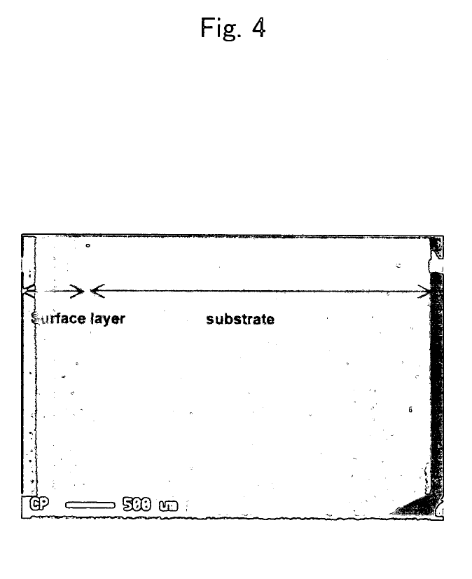

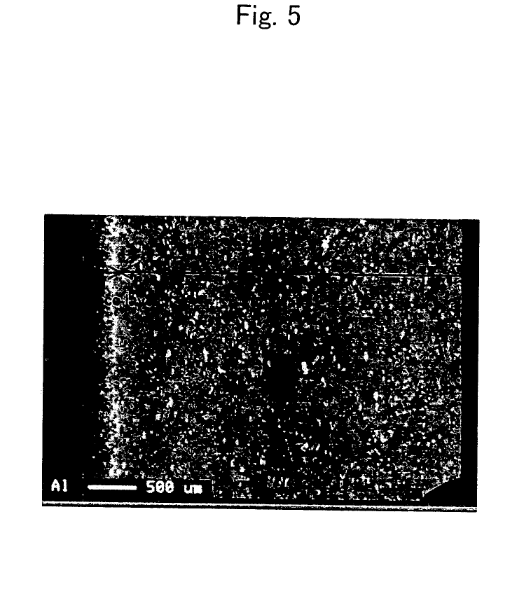

As described above, the ceramic vacuum chuck according to the present invention was proved to be effective for reducing the number of particles and maintaining Young's modulus at a high value. FIG. 4 is a photograph showing backscattering electron image of the laminated body (hybrid sintered body) of the substrate portion and surface layer in the sample of example 5. FIG. 5 is a photograph showing results of Al element mapping of the laminated body of the substrate portion and surface layer in the sample of example 5.

### Example of Production of an Electrostatic Chuck

The electrostatic chuck 1A schematically shown in FIG. 1 was produced according to conditions shown in table 2. The substrate portion 6 was shaped with α-type SiC powder having an average grain diameter of 1.5 μm and a purity of 99.9 weight percent or higher (Fe 13 ppm; Ti 3 ppm; Cr 1 ppm; Ni 2 ppm; Na<1 ppm; K<1 ppm) . 4 percent of boron nitride powder having a purity of 99 percent or higher and an average grain diameter of 0.6 μm was added to the α-type SiC powder as a sintering aid, mixed together with an organic binder, and granulated to obtain granulated powder. The granulated powder was filled in a metal mold having a diameter φ of 302 mm and pressed at a pressure of 10 MPa. According to example 8, 20 weight percent of AlN powder having a purity of higher than 99.9 percent was further added as the example 5.

β-type SiC powder of a high purity (Fe<1 ppm; Ti 2 ppm; Cr<1 ppm; Ni<1 ppm; Na<1 ppm; K<1 ppm; an average grain diameter of 1.3 μm), boron carbide powder having a purity of 99.5 percent or higher and an average grain diameter of 0.8 μm, carbon powder having an average grain diameter of 0.3 μm and an organic binder were mixed and granulated to obtain granulated powder. The granulated powder was filled on the pressed shaped body for the substrate portion in the metal mold, and pressed again at a pressure of 8 MPa to shape the surface layer to obtain a hybrid shaped body.

A metal mesh 7 made of tungsten was embedded in the hybrid shaped body at a depth of about 1 mm from the surface 2a of the chuck. A metal mesh made of tungsten was cut out to obtain a strip having a width of 5 mm, which was then embedded in the hybrid shaped body as a heating resistance 8 at a depth of about 5 mm from the surface 2a. Finally, one hole for electrostatic chuck and two holes for heating resistance were processed from the back face 6a of the chuck. Tungsten terminals 10 and 9 were inserted into the corresponding holes, respectively, and joined with the metal mesh 7 and heating resistance 8, respectively, to provide a heater with a function of electrostatic chucking.

Prior to the measurement of particles, the electrical resistance of the surface of the heater was measured and proved to be 8×10⁷ to 9×10⁸ Ω·cm at room temperature. The samples of the materials were cut out and the electrical resistances were measured by three terminal method to prove that the resistances were 1×10⁹ to 1×10¹² Ω·cm at room temperature. Although the tungsten mesh had a wire diameter 0 of 0.1 mm and is of 30 mesh according to the present example, the mesh having a wire diameter φ of 0.05 to 0.5 mm may be embedded in the chuck. The surface may be processed to form embossed portions or grooves on the surface depending on various applications. Such processing leaves gaps on the surface of the chuck, which may be filled with helium or a gas of a high thermal conduction at a pressure which does not prevent the adsorption force required for chucking.

A direct current voltage of 300 volts was applied on the electrode 7 for electrostatic chuck, while the heating resistance 8 was powered to elevate the temperature of the chuck at 60° C., for chucking a wafer. The number of particles on the wafer after the chucking was measured.

TABLE 2

| | Example | Example | Example |
|---|---|---|---|
| | 6 | 7 | 8 |
| Porosity of surface | 3 | 5 | 3 |
| Layer (%) | | | |
| Thickness of surface | 1.5 | 2.0 | 1.5 |
| Layer (mm) | | | |
| Porosity of substrate | 0.7 | 0.7 | <0.1 |
| portion (%) | | | |
| Number of particles | 730 | 810 | 710 |
| (as vacuum chuck | | | |
| >0.2 μm | | | |
| particles/wafer) | | | |
| Number of particles | 670 | 850 | 770 |
| (as electrostatic chuck | | | |
| >0.2 μm | | | |
| particles/wafer) | | | |

As described above, the ceramic chuck of the present invention is effective for reducing the number of particles and for maintaining Young's modulus of the chuck at a high value.

The present invention has been explained referring to the preferred embodiments, however, the present invention is not limited to the illustrated embodiments which are given by way of examples only, and may be carried out in various modes without departing from the scope of the invention.

1. A ceramic chuck comprising a surface layer contacting a wafer and a substrate portion, wherein said surface layer and said substrate portion are produced by co-sintering and wherein said surface layer has a porosity of 1% or higher and 10% or lower and larger than that of said substrate portion.

2. The ceramic chuck of claim 1, wherein said surface layer comprises a first ceramic material and said substrate portion comprises a second ceramic material, and wherein said first and second ceramic materials comprise SiC in a content of 67% or higher.

3. The ceramic chuck of claim 1, wherein said surface layer has a volume resistivity of 1×10⁹ Ω·cm or lower at room temperature.

4. The ceramic chuck of claim 1, wherein said surface layer comprises a ceramic material having a total content of alkali metal and transition metal elements of 50 ppm or lower.

5. The ceramic chuck of claim 1, wherein said surface layer has a thickness of 0.5 mm or larger.

6. The ceramic chuck of claim 1, wherein said surface layer has a thickness of 25% or smaller of that of said ceramic chuck.

7. The ceramic chuck of claim 1, comprising a vacuum chuck or an electrostatic chuck.

8. The ceramic chuck of claim 1, comprising a heater element.

9. The ceramic chuck of claim 1, comprising an electrode for generating high frequency.
